(19) United States
(12) Patent Application Publication
(10) Pub. No.: US 2001/0031632 A1
(43) Pub. Date: Oct. 18, 2001

(54) Method for transmitting organization information items

(76) Inventors: Michael Benz, Berlin (DE); Anja Klein, Berlin (DE); Armin Sitte, Berlin (DE); Thomas Ulrich, Bad Durkheim (DE)

Correspondence Address: LERNER AND GREENBERG, P.A., POST OFFICE BOX 2480, HOLLYWOOD, FL, 33022-2480, US

(21) Appl. No.: 09/748,805

(22) Filed: Dec. 26, 2000

Related U.S. Application Data
(63) Continuation of application No. PCT/DE99/01612, filed on Jun. 1, 1999.

(30) Foreign Application Priority Data
Jun. 23, 1998 (DE) 198 27 913.2

(51) Int. Cl. H04M 3/42

(52) U.S. Cl. 455/414; 455/466; 455/422; 455/517

(57) ABSTRACT

A method for transmitting organization information items from a base station to mobile stations in a radio communications system which offers a plurality of services within a radio cell of the base station. The organization information items are subdivided into first and second organization information items on the basis of the services requested at a given moment and only the first organization information items are transmitted. As a result, the currently required information items are made available in a manner that saves resources, yet the integration of new services is made possible. The method is suitable for TDMA/CDMA and CDMA transmission systems.

### CROSS-REFERENCE TO RELATED APPLICATION

This is a continuation of copending International Application PCT/DE99/01612, filed Jun. 1, 1999, which designated the United States.

### BACKGROUND OF THE INVENTION

The invention relates to a method for transmitting organization information items from a base station to mobile stations in a radio communications system, in particular in a mobile radio system having broadband channels in which signals are transmitted according to a CDMA or TDMA/CDMA subscriber separation method.

In radio communications systems, information (for example voice information in the GSM mobile radio network) is transmitted with the aid of electromagnetic waves via a radio interface between the transmitting and receiving radio stations (base station or mobile station). In this case, the electromagnetic waves are radiated with carrier frequencies within the frequency band provided for the respective system. Frequencies in the frequency band of approximately 2000 MHz are envisaged for future mobile radio systems having CDMA or TDMA/CDMA transmission methods via the radio interface, for example the UMTS (Universal Mobile Telecommunication System) or other 3^{rd} generation systems.

For transmitting organization information items, various methods are known which serve for supplying mobile stations in a radio cell of a base station with the data which are required for the radio cell. Organization information items are details regarding the radio cell, the channel structure thereof and services and options which are available in the radio cell. The organization information items are thus used by the mobile station for the synchronization and selection of the radio cell.

From the GSM mobile radio system and, for future mobile radio systems, from DE 198 10 285, it is known to provide a time slot for transmitting organization information items per frame in the downlink direction. To that end, use is usually made of the first time slot of the frame and the information items are transmitted in radio blocks, i.e. in a burst-like manner. There are thus fixed spacings between the transmissions of the organization information items, which are planned in such a way that even in unfavorable traffic load situations and with the maximum permitted speed of the mobile stations, a proper evaluation of the organization information items and a handover of the mobile stations between different radio cells are supported.

Since the resources for transmitting organization information items are limited in order not to excessively restrict the capacity of the radio interface, when new services are introduced there is the problem of transmitting organization information items which are associated with these services to the mobile stations.

### SUMMARY OF THE INVENTION

It is accordingly an object of the invention to provide a method for transmitting organization information items which overcomes the above-mentioned disadvantageous of the prior art methods of this general type and which supports a large number of services.

With the foregoing and other objects in view there is provided, in accordance with the invention, a method for transmitting organization information items from a base station to mobile stations in a radio communications system that offers a plurality of services within a radio cell of a base station. The organization information items are subdivided into first and second organization information items on the basis of the services requested at a given moment and only the first organization information items are transmitted. As a result all the currently required information items, e.g. for a connection setup, are made available and, for new services, are nevertheless kept open to the possibility of integration of the organization information items thereof in the organization channel.

In accordance with an added feature of the invention, renewed subdivision of the organization information items is carried out in the event of a request of a service by the mobile station or by a component at the network end. The structure of the transmitted organization information items is thus continuously demand-oriented.

In accordance with an additional feature of the invention, the most frequently required organization information items are continuously allocated to the first organization information items. These organization information items are, by way of example, information items for simple voice information transmission or packet data transmission.

In accordance with another feature of the invention, the transmission via the radio interface is accomplished with a frame structure, and the elements of the organization information items are transmitted with different frequency within the frame structure. Better information is provided about more frequently requested services or standard information items of the radio cell and its neighbors than about unusual services or events which are connected, for example, with the startup of a base station or the introduction of a service, e.g. software download. In these cases, it is advantageous for individual elements of the organization information items to be transmitted only upon an inquiry.

In accordance with a concomitant feature of the invention, a timer is provided which monitors the transmission of the organization information items, so that a group of elements of the organization information items are transmitted at least once after a predeterminable time, even without an inquiry. The basic supply of information is thus guaranteed in conjunction with extremely low resource consumption.

Other features which are considered as characteristic for the invention are set forth in the appended claims.

Although the invention is illustrated and described herein as embodied in a method for transmitting organization information items, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows a block diagram of a mobile radio system,

FIG. 2 shows a schematic illustration of the frame structure of the transmission method,

FIG. 3 shows a schematic structuring of a radio block with organization information items, and

FIG. 4 shows a simplified flow chart of the restructuring of the organization information items.

### DESCRIPTION OF THE PREFERRED EMBODIMENTS

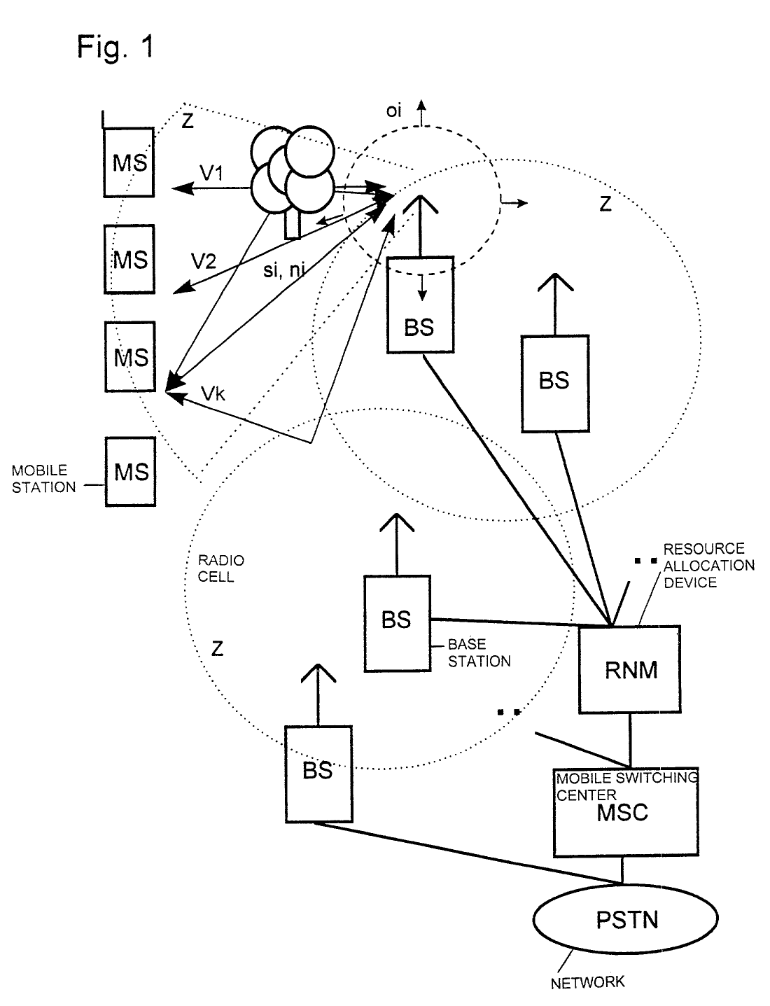

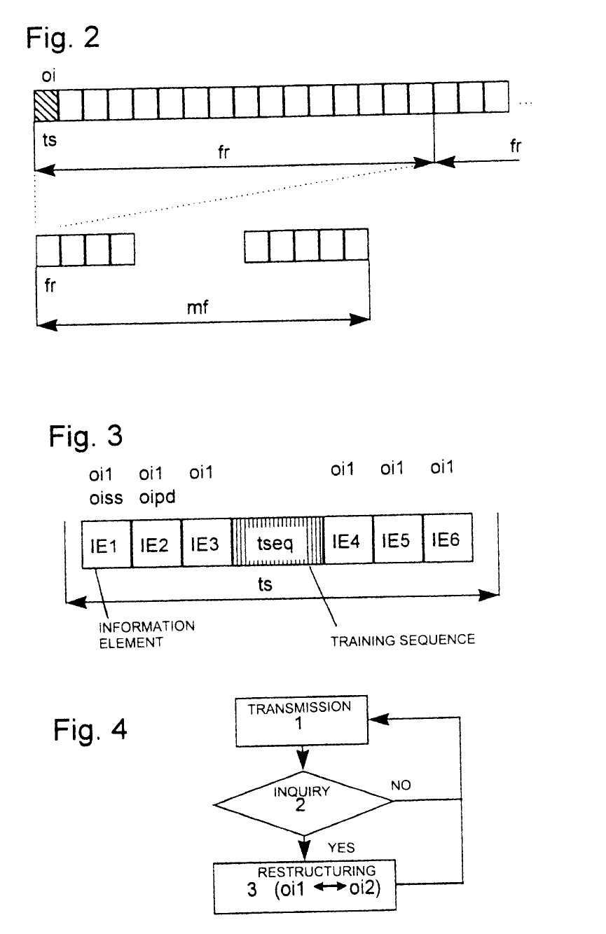

Referring now to the figures of the drawing in detail and first, particularly, to FIG. 1 thereof, there is shown an example of a radio communications system, specifically, a mobile radio system that includes a multiplicity of mobile switching centers MSC which are internetworked and establish access to a fixed network PSTN. Furthermore, these mobile switching centers MSC are each connected to at least one device RNM for allocation of radio resources. Each of these devices RNM in turn enables a connection to at least one base station BS. Such a base station BS can set up a connection, via a radio interface, to further radio stations, e.g. mobile stations MS or other mobile and stationary terminals. At least one radio cell Z is formed by each base station BS. In addition, a plurality of radio cells Z are supplied per installed base station BS in the event of sectorization or with hierarchical cell structures. The device RNM for allocation of radio resources and a plurality of base stations BS form a base station system.

FIG. 1 illustrates connections V, designated by way of example as V1, V2, Vk, for transmitting useful information items ni and signaling information items si between mobile stations MS and a base station BS. The transmission of organization information items oi is effected to a plurality of mobile stations MS in the form of a point-to-multipoint connection.

An operation and maintenance center OMC realizes monitoring and maintenance functions for the mobile radio system, or for parts of it. The functionality of this structure can be transferred to other radio communications systems in which the invention can be used, in particular for subscriber access networks with wire-free subscriber access. Base stations which are used as home base stations in the private sector, without being affected by the radio network planning, can also set up connections to mobile stations MS. These home base stations are connected to a fixed network.

Without restricting the generality of the method, reference is made hereinafter to the TDD transmission method with TDMA/CDMA subscriber separation that is shown in DE 198 17 771.

TDMA subscriber separation is employed in a broadband frequency band, so that a frame fr with 16 time slots ts is produced. The time slots ts of a frame fr are utilized both for the uplink direction and for the downlink direction for the transmission of information items oi, si, ni. There is a switching point between the transmission directions. The first time slot of the frame fr serves, for example, continually for the transmission of organization information items oi from the base station BS to the mobile stations MS. A utilization of physical channels which is variable in this regard is also possible. A plurality of frames fr are combined to form a multiframe mf. Furthermore, a plurality of multiframes mf can in turn be combined to form a higher-order frame.

According to FIG. 3, a radio block having first organization information items oi1 which are intended to be transmitted includes a training sequence tseq for channel estimation at the receiving end and two data portions which are structured for example into six information elements IE1 to IE6. The allocation of the individual elements to the totality of the organization information items oi is specified by the structure of the organization information items oi.

The invention describes this structure of the organization information items oi, which, unlike in the case of the GSM mobile system, do not provide a rigid scheme of uniform transmission of organization information items oi, but rather fits the organization information oi into the frame structure in a demand-conforming manner.

In the 3^{rd} mobile radio generation, some services are intended to be offered with full coverages and others only in specific radio cells, for example in the unlicensed domestic sector. The multiplicity of services include voice services, emergency call services, short message services, teletext services, facsimile services, internet services or image transmission services, each of which is also offered with varying data rates, options and security mechanisms. The organization information items oi provide information about the availability of these services and also about the adjacent cells, particular events such as software download, or of other information items which are required by all the mobile stations MS.

In accordance with the invention, discrimination is effected into organization information items oi which are transmitted continuously, frequently, seldom or only upon an inquiry. Continuously required information items are those about the standard services, e.g., about simple voice information transmission or packet data transmission, for which individual organization information items (oiss, oipd) are transmitted in information elements IE1 and IE2 in each radio block with organization information items oi.

Frequently required information items are those about additional services or about adjacent cells which are required, for example, for transferring a connection from cell to cell. These information items occupy the information elements IE3 to IE5 according to a rotation scheme.

Services that are seldom required are those about general messages in the network, new program versions or unusual services. These information items are transmitted in the sixth information element IE6. An example of organization information items which are transmitted only on request is the announcement of the installation of a new base station BS, the transmission of an overlong training sequence tseq for synchronization purposes or the request to the mobile stations MS to avoid a base station BS for a certain time since a very high-rate service requires large portions or the entire radio resources of the base station BS. At least the sixth information element IE6 can be utilized for these information items, as a result of which the infrequent services are suppressed. However, a timer guarantees that all the information items—except for the purely demand-related ones —are transmitted at least once, in a higher-order frame.

The totality of these organization information items oi forms a pool which is subdivided in order to extract first organization information items oi1 for transmission in the next reserved time slot ts. The remaining, second organization information items oi2 are transmitted at later points in time depending on their prioritization. The prioritization can be set by the base station BS in interaction with the organization and maintenance center OMC.

FIG. 4 briefly outlines the sequence of restructuring the transmission of the organization information items oi. In a first step 1, transmission of first organization information items oi1 is carried out in accordance with the set scheme, the content of the first organization information items oi1 varying from frame fr to frame fr. In a second step 2, an inquiry of a mobile station MS for an infrequent service is performed, whereupon the base station BS checks whether information items regarding this service are available. If this is the case, then, in a third step 3, restructuring of the organization information items oi takes place and the organization information items oi provided for the requested service are transmitted as soon as possible. In some instances, an exchange takes place between the first and second organization information items oi1, oi2. Otherwise, the structure remains unchanged.

We claim:

1. A method for transmitting organization information items from a base station to mobile stations in a radio communications system, which comprises:
offering a plurality of services within a radio cell of the base station;
subdividing organization information items into first and second organization information items based on a service requested at a given moment; and
transmitting the first organization information items.

2. The method according to claim 1, wherein the transmitting step is performed by transmitting only the first organization information items.

3. The method according to claim 1, which comprises performing a renewed subdivision of the organization information items if a service is requested by a component selected from the group consisting of a mobile station and a component at a network end.

4. The method according to claim 1, which comprises continuously allocating organization information items to the first organization information items.

5. The method according to claim 4, wherein the organization information items are for information selected from the group consisting of simple voice information transmission and packet data transmission.

6. The method according to claim 1, which comprises transmitting elements of the organization information items with different frequency within a frame structure of the transmission.

7. The method according to claim 1, which comprises transmitting individual elements of the organization information items only upon an inquiry.

8. The method according to claim 1, which comprises using a timer to monitor the transmission of the organization information items so that a group of elements of the organization information items are transmitted at least once after a predetermined time, even without an inquiry.
